(19) United States
(12) Patent Application Publication
(10) Pub. No.: US 2026/0290860 A1
(43) Pub. Date: Sep. 24, 2026

(54) FUEL CELL STACK

(71) Applicant: HONDA MOTOR CO., LTD., Tokyo (JP)

(72) Inventors: Fumiya ARAI, Saitama (JP); Tomoki HORI, Saitama (JP); Masaru YOSHIDA, Tokyo (JP)

(21) Appl. No.: 19/556,428

(22) Filed: Mar. 4, 2026

(30) Foreign Application Priority Data
Mar. 24, 2025 (JP) 2025-048217

(51) Int. Cl. H01M 8/04119

(52) U.S. Cl. CPC H01M 8/04156

(57) ABSTRACT

A fuel cell stack includes: an end unit disposed at an end of a cell stack body; and a communicating tube disposed in an exhaust gas flow path to form a generated water discharge flow path extending in an extension direction of the exhaust gas flow path. The end unit has an engagement part engaging with an end portion of the communicating tube. The end unit has, in a part constituting a bottom portion of the exhaust gas flow path, a shoulder portion which is provided with a first surface facing an upstream open end of the communicating tube and a second surface extending from an upper edge of the first surface and facing upward. The shoulder portion has a cutout part that opens across the first and second surfaces. An internal passage of the communicating tube communicates with the exhaust gas flow path via the cutout part.

### TECHNICAL FIELD

The present invention relates to a fuel cell stack.

### BACKGROUND ART

In recent years, research and development are being conducted in relation to fuel cells which can contribute to energy efficiency to ensure that a greater number of people can access reliable, sustainable, and advanced energy at reasonable cost.

There is known a fuel cell stack in which, to discharge the water generated secondarily by electrochemical reaction of the reaction gas in the fuel cell stack to the outside of the fuel cell stack, a communicating tube for guiding discharge of the generated water is disposed in the reaction gas exhaust passage of the fuel cell stack (for example, JP2024-126790A and JP6690574B2).

The communicating tube extends in the stacking direction of multiple power generation cells provided in the fuel cell stack and one end thereof is inserted in one end of an engagement hole provided in an end unit disposed at an end portion of the fuel cell stack, whereby the communicating tube is supported by the end unit. Due to this support, positioning of the communicating tube relative to the end unit in the stacking direction and directions perpendicular to the stacking direction is achieved.

However, in the conventional technology mentioned above, the other end of the engagement hole needs to be opened to the reaction gas exhaust passage to introduce the generated water into the communicating tube. This results in an increase in the length of the end unit in the stacking direction at the part supporting the communicating tube, namely, an increase in size of the end unit. The increase in size of the end unit can lead to an increase in size of the overall fuel cell stack, making it difficult to achieve a compact fuel cell stack.

To avoid this, it may be conceived to make an arrangement such that the end surface of the communicating tube contacts a wall surface of a vertical wall provided in an end portion of the exhaust gas passage configured by the end unit.

In this case, it may be possible to avoid an increase in the length of the end unit in the stacking direction at the part supporting the communicating tube, but since the end surface of the communicating tube is in contact with the wall surface, a part of the communicating tube is closed by the wall surface. Therefore, the effective passage area of the communicating tube is reduced and the capacity of discharging the generated water is lowered.

### SUMMARY OF THE INVENTION

In view of the foregoing background, an object of the present invention is to provide a fuel cell stack in which required drainage capacity is obtained without increasing the size of the fuel cell stack. Moreover, the present invention is intended to contribute to energy efficiency.

To achieve the above object, one aspect of the present invention provides a fuel cell stack, comprising: a cell stack body composed of multiple power generation cells stacked in a predetermined direction; and a first end unit and a second end unit respectively disposed at both ends of the cell stack body in a stacking direction thereof, wherein the cell stack body is provided with an exhaust gas flow path extending in the stacking direction of the cell stack body to discharge, from the power generation cells, a reaction gas supplied to the power generation cells, the fuel cell stack further comprising: a communicating tube disposed in the exhaust gas flow path and forming a generated water discharge flow path extending in a same direction as an extension direction of the exhaust gas flow path, the communicating tube having openings at both ends; a first engagement part formed in the first end unit and engaging with one end portion of the communicating tube; and a second engagement part formed in the second end unit and engaging with the other end portion of the communicating tube, wherein the second end unit has, in a part constituting a bottom portion of the exhaust gas flow path, a shoulder portion which is provided with a first surface facing an upstream open end of the communicating tube and a second surface extending from an upper edge of the first surface and facing upward, the shoulder portion has a cutout part that opens across the first surface and the second surface, and an internal passage of the communicating tube communicates with the exhaust gas flow path via the cutout part.

According to the present invention, required drainage capacity is obtained without increasing the size of the fuel cell stack.

### BRIEF DESCRIPTION OF THE DRAWINGS

FIG. 1 is a perspective view schematically showing an overall configuration of a fuel cell stack according to an embodiment;

FIG. 2 is a vertical sectional view of the fuel cell stack according to the embodiment;

FIG. 3 is an enlarged vertical sectional view of a main part of the fuel cell stack according to the embodiment;

FIG. 4 is a perspective view of the main part of the fuel cell stack according to the embodiment;

FIGS. 5A to 5C are explanatory diagrams showing examples of a groove shape of a cutout part of the fuel cell stack according to the embodiment; and

FIG. 6 is an enlarged vertical sectional view of a main part of a fuel cell stack according to another embodiment.

### DETAILED DESCRIPTION OF THE INVENTION

In the following, an embodiment of a fuel cell stack 10 will be described with reference to the drawings. Note that in the following description, three orthogonal axes in the front-rear direction, the left-right direction, and the up-down direction are defined as shown in the drawings.

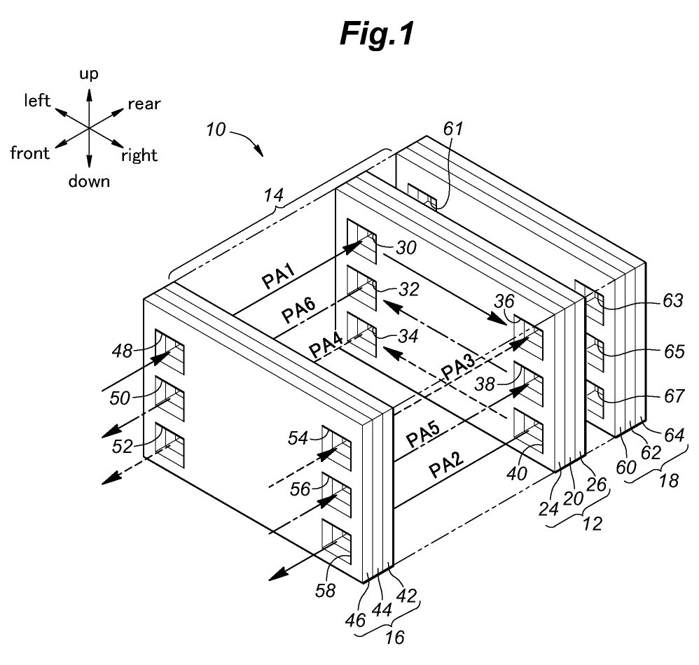

First, an overall structure of the fuel cell stack 10 will be described with reference to FIG. 1. The fuel cell stack 10 includes a cell stack body 14 composed of multiple power generation cells 12 stacked in the front-rear direction (predetermined direction), a wet-side end unit 16 (the first end unit) disposed at one end portion of the cell stack body 14 in the stacking direction, and a dry-side end unit 18 (the second end unit) disposed at the other end portion of the cell stack body 14 in the stacking direction. The wet-side end unit 16 and the dry-side end unit 18 are fastened to the cell stack body 14 in the stacking direction by means of fastening members not shown in the drawings, and they are contained in a stack case not shown in the drawings.

The fuel cell stack 10 is supplied with hydrogen gas (fuel gas) and oxidizer gas (air) as reaction gases.

In the following description, the stacking direction of the cell stack body 14 may be referred to as the front-rear direction.

Each power generation cell 12 includes an electrolyte membrane-electrode structure 20 having a rectangular plate shape, a first separator 24 disposed on one side of the electrolyte membrane-electrode structure 20, and a second separator 26 disposed on the other side of the electrolyte membrane-electrode structure 20. A left edge part of each power generation cell 12 is formed with a hydrogen gas supply opening 30, a coolant discharge opening 32, and an oxidizer gas discharge opening 34 arranged in order from above and each extending through the power generation cell 12 in the stacking direction. A right edge part of each power generation cell 12 is formed with an oxidizer gas supply opening 36, a coolant supply opening 38, and a hydrogen gas discharge opening 40 arranged in order from above and each extending through the power generation cell 12 in the stacking direction.

The wet-side end unit 16 includes a terminal plate 42, an electrical insulation plate 44, and an end plate 46 which are stacked in order from the side of the power generation cells 12. A left edge part of the wet-side end unit 16 is formed with a hydrogen gas supply opening 48, a coolant discharge opening 50, and an oxidizer gas discharge opening 52 arranged in order from above and each extending through the wet-side end unit 16 in the front-rear direction. A right edge part of the wet-side end unit 16 is formed with an oxidizer gas supply opening 54, a coolant supply opening 56, and a hydrogen gas discharge opening 58 arranged in order from above and each extending through the wet-side end unit 16 in the front-rear direction. The openings provided in the wet-side end unit 16 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

The hydrogen gas supply opening 48 communicates with the hydrogen gas supply opening 30 of the power generation cell 12. The coolant discharge opening 50 communicates with the coolant discharge opening 32 of the power generation cell 12. The oxidizer gas discharge opening 52 communicates with the oxidizer gas discharge opening 34 of the power generation cell 12. The oxidizer gas supply opening 54 communicates with the oxidizer gas supply opening 36 of the power generation cell 12. The coolant supply opening 56 communicates with the coolant supply opening 38 of the power generation cell 12. The hydrogen gas discharge opening 58 communicates with the hydrogen gas discharge opening 40 of the power generation cell 12.

The dry-side end unit 18 includes a terminal plate 60, an electrical insulation plate 62, and an end plate 64 which are stacked in order from the side of the power generation cells 12. The terminal plate 60 and the electrical insulation plate 62 are formed with a hydrogen gas supply opening 61, a hydrogen gas discharge opening 67, an oxidizer gas supply opening 63, an oxidizer gas discharge opening (not shown in the drawings), a coolant supply opening 65, and a coolant discharge opening (not shown in the drawings) arranged in the same manner as the openings of the wet-side end unit 16 and each extending through the terminal plate 60 and the electrical insulation plate 62 in the front-rear direction. Note that the end plate 64 is not formed with these openings. The openings provided in the dry-side end unit 18 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

Thereby, the hydrogen gas flows in the stacking direction of the cell stack body 14 through a gas supply flow path PA1 to be supplied to each power generation cell 12. The hydrogen off-gas (exhaust gas) generated at each power generation cell 12 flows from each power generation cell 12 in the stacking direction of the cell stack body 14 through an exhaust gas flow path PA2.

The oxidizer gas may be air and flows in the stacking direction of the cell stack body 14 through a gas supply flow path PA3 to be supplied to each power generation cell 12. The oxidizer off-gas (exhaust gas) generated at each power generation cell 12 flows from each power generation cell 12 in the stacking direction of the cell stack body 14 through an exhaust gas flow path PA4.

The coolant may be water or the like and flows in the stacking direction of the cell stack body 14 through a coolant supply flow path PA5 to be supplied to each power generation cell 12 to cool each power generation cell 12. The coolant discharged from each power generation cell 12 flows in the stacking direction of the cell stack body 14 through a coolant discharge flow path PA6.

In the fuel cell stack 10, electron and water are generated by the electrochemical reaction of the hydrogen gas and the oxidizer gas supplied to each power generation cell 12, and electric power is taken out from the terminal plates 42 and 60. The water generated in the fuel cell stack 10 is discharged to the outside of the fuel cell stack 10 through the exhaust gas flow paths PA2 and PA4.

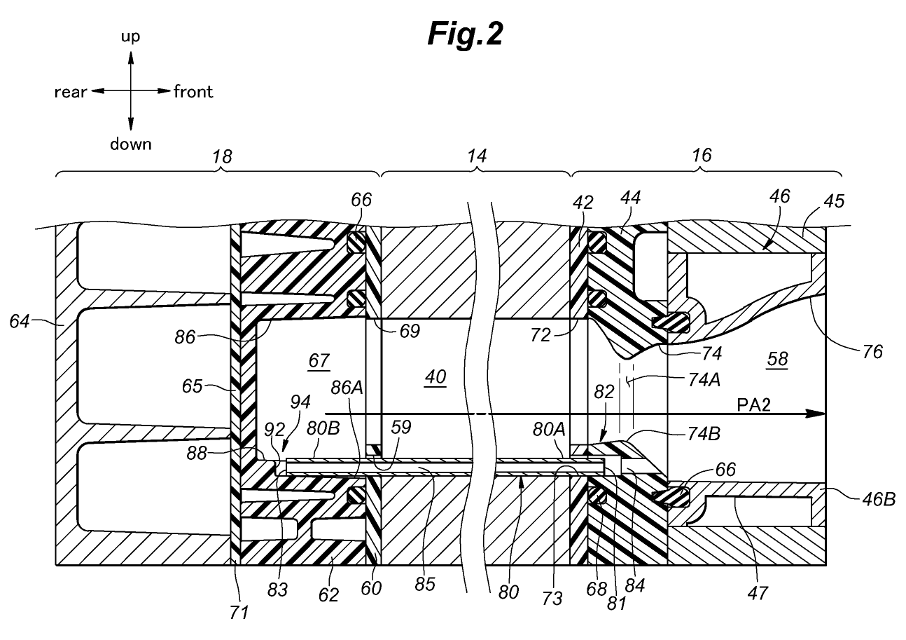

Next, details of the exhaust gas flow path PA2 of the fuel cell stack 10 will be described with reference to FIG. 2 to FIG. 5A. Note that in FIG. 2 to FIG. 5A, parts corresponding to those shown in FIG. 1 are denoted by the same reference signs as in FIG. 1, and the description thereof will be omitted.

As shown in FIG. 2, the end plate 46 of the wet-side end unit 16 includes a port arrangement plate 45 and a port member 47 mounted in the port arrangement plate 45. An airtight seal member 66 is provided between the port member 47 and the electrical insulation plate 44. An airtight seal member 68 is provided between the electrical insulation plate 44 and the terminal plate 42.

The terminal plate 42, the electrical insulation plate 44, and the port member 47 of the wet-side end unit 16 are respectively formed with through holes 72, 74, and 76 constituting the hydrogen gas discharge opening 58. The through hole 72 and 76 are straight holes having predetermined cross-sectional shapes. The through hole 74 is a throat hole having a narrowed part 74A. The narrowed part 74A is defined by an annular projection 74B that protrudes radially inward from a peripheral wall of the through hole 74 of the electrical insulation plate 44.

An airtight seal member 66 is provided between the terminal plate 60 and the electrical insulation plate 62 of the dry-side end unit 18. A gasket 71 is provided between the electrical insulation plate 62 and the end plate 64. The terminal plate 60 of the dry-side end unit 18 is formed with a through hole 69 constituting the hydrogen gas discharge opening 67. The electrical insulation plate 62 is formed with a non-through hole 86 constituting the hydrogen gas discharge opening 67.

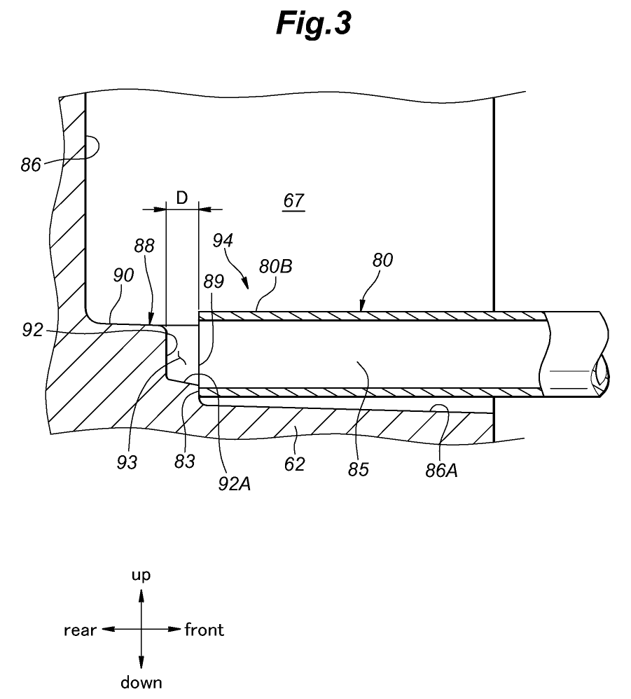

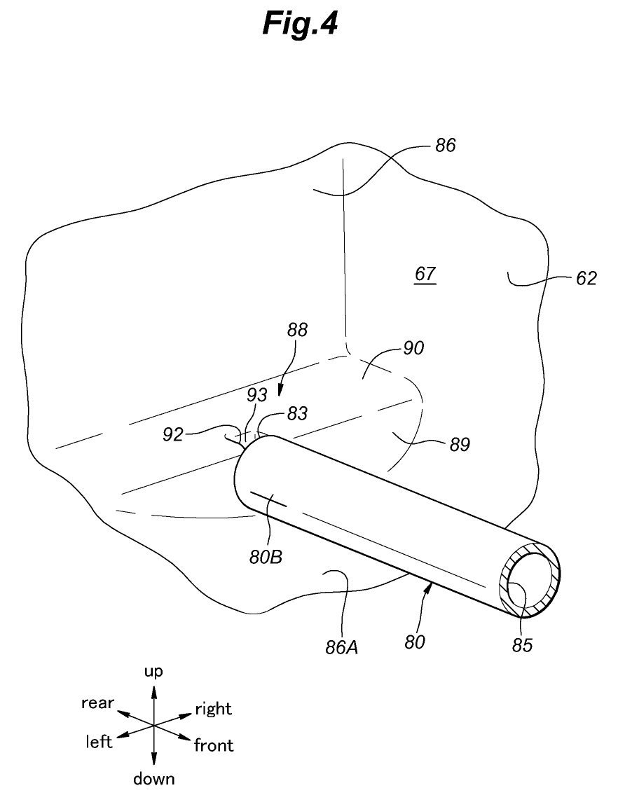

The bottom surfaces of the hydrogen gas discharge openings 40 and 67 (the through hole 69 and the non-through hole 86) constituting the exhaust gas flow path PA2 (description will be made of a bottom surface 86A of the non-through hole 86 of the electrical insulation plate 62 shown in FIG. 4 as a representative) are shaped to become deeper toward the right (toward the outer edge of the fuel cell stack 10) and have a drainage slope (see FIG. 3) toward the front.

As shown in FIG. 2 to FIG. 4, the electrical insulation plate 62 of the dry-side end unit 18 has a shoulder portion 88 at a lower portion of the non-through hole 86. The shoulder portion 88 has a substantially vertical first surface 89 standing from the bottom surface 86A of the non-through hole 86 and facing forward and a substantially horizontal second surface 90 continuous with an upper edge of the first surface 89 and facing upward.

In other words, the dry-side end unit 18 has, in a part constituting a bottom portion of the exhaust gas flow path PA2, the shoulder portion 88 which is provided with the first surface 89 extending substantially vertically and the second surface 90 extending from the upper edge of the first surface 89 and facing upward. As described in the following, the first surface 89 faces an upstream opening of a communicating tube 80.

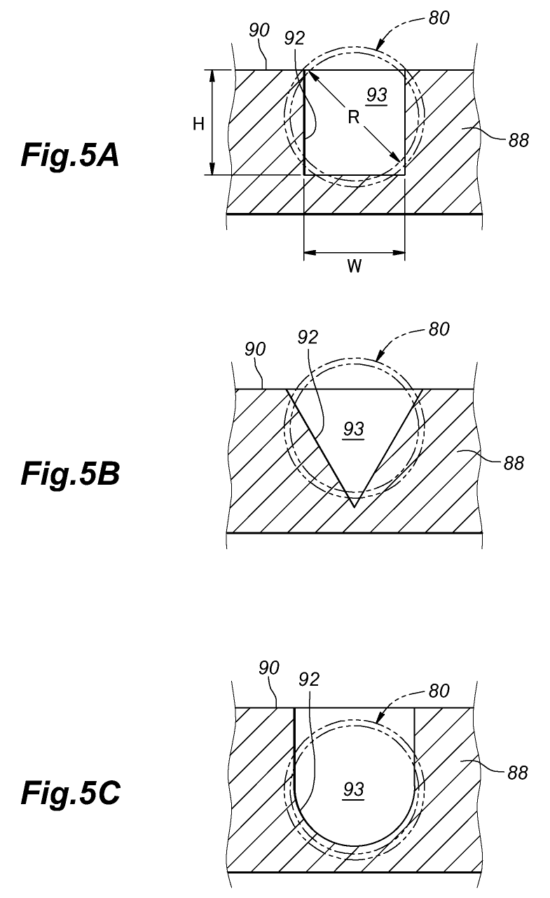

In the exhaust gas flow path PA2, a communicating tube 80 is provided as a member forming a generated water discharge flow path extending in the same direction as the extension direction of the exhaust gas flow path PA2. The communicating tube 80 extends substantially horizontally along the stacking direction of the cell stack body 14 in a lower part of the hydrogen gas discharge opening 40 of the cell stack body 14 (the power generation cells 12). The communicating tube 80 is composed of a straight round tube and, as shown in FIG. 5A, has an annular cross-sectional shape.

The communicating tube 80 has an internal passage 85 which constitutes a generated water discharge flow path extending in the same direction as the extension direction of the exhaust gas flow path PA2 inside the exhaust gas flow path PA2, more specifically, in a lower portion of the exhaust gas flow path PA2.

The electrical insulation plate 44 of the wet-side end unit 16 has a first engagement part 82 with which one end portion 80A (in the following description, may be referred to as the outlet end portion 80A) of the communicating tube 80 engages. The electrical insulation plate 62 of the dry-side end unit 18 has a second engagement part 94 with which the other end portion 80B (in the following description, may be referred to as the inlet end portion 80B) of the communicating tube 80 engages.

The first engagement part 82 has an engagement hole 84 extending through a part of the electrical insulation plate 44 of the wet-side end unit 16 below the annular projection 74B in the front-rear direction (stacking direction). The engagement hole 84 extends in a substantially horizontal direction and has openings on both ends, whereby the engagement hole 84 is open toward both the hydrogen gas discharge opening 40 of the cell stack body 14 and the hydrogen gas discharge opening 58 of the end plate 46.

In the engagement hole 84, the outlet end portion 80A of the communicating tube 80 is inserted from the side of the cell stack body 14. Due to this insertion, the outlet end portion 80A of the communicating tube 80 is held by the electrical insulation plate 44. Thereby, the stability of holding the communicating tube 80 in the fuel cell stack 10 is improved.

A first open end 81 (downstream-side open end) of the communicating tube 80 on the side of the outlet end portion 80A is open toward the hydrogen gas discharge opening 58 of the end plate 46.

A part of the terminal plate 42 of the wet-side end unit 16 below the through hole 72 is formed with a through hole 73 in which the communicating tube 80 is fitted. With this fitting, the outlet end portion 80A of the communicating tube 80 is supported by the terminal plate 42. Thereby, the terminal plate 42 is effectively used to hold the communicating tube 80.

A part of the terminal plate 60 of the dry-side end unit 18 below the through hole 69 is formed with a through hole 59 in which the communicating tube 80 is fitted. With this fitting, the inlet end portion 80B of the communicating tube 80 is supported by the terminal plate 60. Thereby, the terminal plate 42 is effectively used to hold the communicating tube 80.

At a corner of the shoulder portion 88 formed in the electrical insulation plate 62 of the dry-side end unit 18, a cutout part 92 forming a groove-shaped space 93 that is opened in both the first surface 89 and the second surface 90 is formed. The cutout part 92 has a box-shaped (rectangular) groove shape as viewed in each of the front-rear direction and the up-down direction. The groove-shaped space 93 is opened both upward and forward.

As shown in FIG. 5A and FIG. 3, the vertical dimension H and the lateral dimension W of the cutout part 92 (the groove-shaped space 93) are the same as each other, and the front-rear dimension D of the cutout part 92 is smaller than them. Note that the front-rear dimension D may be the same as or greater than the vertical dimension H and the lateral dimension W.

The second engagement part 94 includes a cutout part 92. The cutout part 92 opposes a second open end 83 (upstream-side open end) of the inlet end portion 80B of the communicating tube 80. As shown in FIG. 5A, the inner diameter R of the communicating tube 80 is slightly greater than or equal to the vertical dimension H and the lateral dimension W of the cutout part 92. Thereby, the second open end 83 of the communicating tube 80 can come into contact with a part of the first surface 89 in the vicinity of the outer edge of the cutout part 92. The movement of the communicating tube 80 in the front-rear direction is restricted by this contact. The communicating tube 80 is provided close to the bottom surface 86A of the non-through hole 86 of the electrical insulation plate 62.

The internal passage 85 of the communicating tube 80 communicates with the groove-shaped space 93 of the cutout part 92 at the second open end 83 on the side of the inlet end portion 80B. Thereby, the groove-shaped space 93 of the cutout part 92 constitutes a hook-shaped communication flow path that makes the internal passage 85 of the communicating tube 80 and the hydrogen gas discharge opening 67 (the exhaust gas flow path PA2) communicate with each other. Note that the bottom surface 92A of the cutout part 92 is an inclined surface having a downward gradient toward the communicating tube 80 to be smoothly connected to the inner peripheral surface of the communicating tube 80.

The water generated due to operation of the fuel cell stack 10 and accumulating in the bottom portion of the hydrogen gas discharge opening 67 (the non-through hole 86) enters the groove-shaped space 93 of the cutout part 92 from the upward opening of the groove-shaped space 93. The generated water that has entered the groove-shaped space 93 flows toward the horizontal opening of the groove-shaped space 93 without being subjected to significant restriction, and then flows into the internal passage 85 of the communicating tube 80. The generated water that has flowed into the internal passage 85 flows through the internal passage 85 toward the outlet end portion 80A of the communicating tube 80, and flows out from the internal passage 85 to the hydrogen gas discharge opening 58 via the engagement hole 84.

According to this structure, the cutout part 92 has a groove shape that opens upward and forward, and compared to a case where a flow path corresponding to the groove-shaped space 93 of the cutout part 92 is formed as a through hole without an upward opening, discharge of the water generated in the fuel cell stack 10 to the outside of the fuel cell stack 10 is performed promptly without significant flow resistance. In other words, the flow resistance of the communicating tube 80 at the inlet part for the generated water is small. Also, the space in the stacking direction of the cell stack body 14 can be reduced.

Thereby, a required drainage capacity with a required drainage speed can be obtained without increasing the size of the dry-side end unit 18, and hence, the fuel cell stack 10.

Further, since the degree of freedom of setting the vertical dimension H, the lateral dimension W, and the front-rear dimension D of the cutout part 92 of the shoulder portion 88 is greater than a through hole, it is easier to increase the size of the groove-shaped space 93 to reduce the flow resistance of the communicating tube 80 for the generated water flowing therein.

Note that the groove shape of the cutout part 92 may be V-shaped as shown in FIG. 5B or may be U-shaped as shown in FIG. 5C. Thus, a wide variety of shapes of the cutout part 92 is allowed and the degree of freedom of design improves.

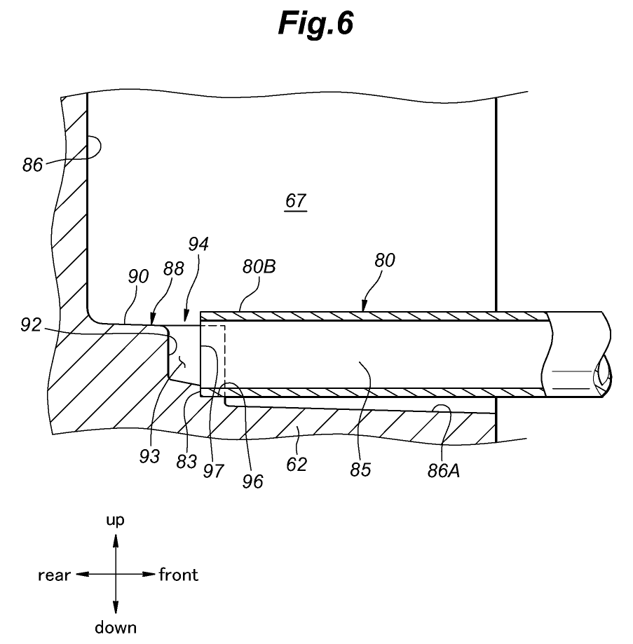

A main part of another embodiment will be described with reference to FIG. 6. Note that in FIG. 6, parts corresponding to those shown in FIG. 3 are denoted by the same reference signs as in FIG. 3, and the description thereof will be omitted.

In the embodiment shown in FIG. 6, the cutout part 92 includes a communicating tube receiving part 96 in which the inlet end portion 80B of the communicating tube 80 is fitted. The communicating tube receiving part 96 has a U-shaped groove shape having a lateral dimension greater than the lateral dimension W of the cutout part 92 and equal to the outer diameter of the communicating tube 80. A U-shaped step wall 97 is formed at the far side of the communicating tube receiving part 96. The step wall 97 is a vertical surface equivalent to the first surface 89.

In this embodiment, since the inlet end portion 80B of the communicating tube 80 is fitted in the communicating tube receiving part 96, support of the communicating tube 80 by the electrical insulation plate 62 becomes firm. Thereby, the stability of holding the communicating tube 80 in the fuel cell stack 10 is improved. The second open end 83 of the communicating tube 80 comes into contact with the step wall 97, whereby the position of the communicating tube 80 relative to the electrical insulation plate 62 in the axial direction is determined.

The embodiments may be modified in various ways without being limited to the above-described configurations. For example, the communicating tube 80 may be provided in the exhaust gas flow path PA4.

The above embodiments may be summarized as follows.

One embodiment is a fuel cell stack 10, comprising: a cell stack body 14 composed of multiple power generation cells 12 stacked in a predetermined direction; and a wet-side end unit 16 (the first end unit) and a dry-side end unit 18 (the second end unit) respectively disposed at both ends of the cell stack body in the stacking direction thereof, wherein the cell stack body 14 is provided with an exhaust gas flow path PA2 extending in the stacking direction of the cell stack body 14 to discharge, from the power generation cells 12, a reaction gas supplied to the power generation cells 12, the fuel cell stack further comprising: a communicating tube 80 disposed in the exhaust gas flow path PA2 and forming a generated water discharge flow path extending in a same direction as an extension direction of the exhaust gas flow path PA2, the communicating tube having openings at both ends; a first engagement part 82 formed in the wet-side end unit 16 and engaging with one end portion 80A of the communicating tube 80; and a second engagement part 94 formed in the dry-side end unit 18 and engaging with the other end portion 80B of the communicating tube 80, wherein the dry-side end unit 18 has, in a part constituting a bottom portion of the exhaust gas flow path PA2, a shoulder portion 88 which is provided with a first surface 89 facing the second open end 83 (upstream open end) of the communicating tube 80 and a second surface 90 extending from an upper edge of the first surface 89 and facing upward, the shoulder portion 88 has a cutout part 92 that opens across the first surface 89 and the second surface 90, and an internal passage 85 of the communicating tube 80 is communicates with the exhaust gas flow path PA2 via the cutout part 92.

According to this aspect, the flow resistance of the communicating tube 80 at the inlet part for the generated water becomes small and the space in the stacking direction of the cell stack body 14 can be reduced, whereby a required drainage capacity is obtained without increasing the size of the fuel cell stack.

In the above aspect, preferably, the first engagement part 82 includes an engagement hole 84 which is formed in the wet-side end unit 16 to extend in the stacking direction to have openings on both ends and in which the one end portion 80A of the communicating tube 80 is inserted.

According to this aspect, the stability of holding the communicating tube 80 in the fuel cell stack 10 is improved.

In the above aspect, preferably, the cutout part 92 includes a communicating tube receiving part 96 in which the other end portion 80B of the communicating tube 80 is fitted.

According to this aspect, the stability of holding the communicating tube 80 in the fuel cell stack 10 is improved.

In the above aspect, preferably, the communicating tube 80 has an annular cross-sectional shape, and the cutout part 92 has a groove shape that is box-shaped, V-shaped, or U-shaped as viewed in the stacking direction.

According to this aspect, a wide variety of shapes of the cutout part 92 is allowed and the degree of freedom of design improves.

In the above aspect, preferably, the dry-side end unit 18 includes an electrical insulation plate 62, and the second engagement part 94 is formed in the electrical insulation plate 62.

According to this aspect, the electrical insulation plate 62 is favorably used to form the second engagement part 94.

In the above aspect, preferably, each of the wet-side end unit 16 and the dry-side end unit 18 includes a terminal plate 42, 60, and each terminal plate 42, 60 has a through hole 73, 59 in which the communicating tube 80 is fitted.

According to this aspect, the terminal plates 42 and 60 are effectively used to hold the communicating tube 80.

What is claimed is:

1. A fuel cell stack, comprising:
a cell stack body composed of multiple power generation cells stacked in a predetermined direction; and
a first end unit and a second end unit respectively disposed at both ends of the cell stack body in a stacking direction thereof,
wherein the cell stack body is provided with an exhaust gas flow path extending in the stacking direction of the cell stack body to discharge, from the power generation cells, a reaction gas supplied to the power generation cells,
the fuel cell stack further comprising:
a communicating tube disposed in the exhaust gas flow path and forming a generated water discharge flow path extending in a same direction as an extension direction of the exhaust gas flow path, the communicating tube having openings at both ends;
a first engagement part formed in the first end unit and engaging with one end portion of the communicating tube; and
a second engagement part formed in the second end unit and engaging with the other end portion of the communicating tube,
wherein the second end unit has, in a part constituting a bottom portion of the exhaust gas flow path, a shoulder portion which is provided with a first surface facing an upstream open end of the communicating tube and a second surface extending from an upper edge of the first surface and facing upward,
the shoulder portion has a cutout part that opens across the first surface and the second surface, and
an internal passage of the communicating tube communicates with the exhaust gas flow path via the cutout part.

2. The fuel cell stack according to claim 1, wherein the first engagement part includes an engagement hole which is formed in the first end unit to extend in the stacking direction to have openings on both ends and in which the one end portion of the communicating tube is inserted.

3. The fuel cell stack according to claim 1, wherein the cutout part includes a communicating tube receiving part in which the other end portion of the communicating tube is fitted.

4. The fuel cell stack according to claim 1, wherein the communicating tube has an annular cross-sectional shape, and the cutout part has a groove shape that is box-shaped, V-shaped, or U-shaped as viewed in the stacking direction.

5. The fuel cell stack according to claim 1, wherein the second end unit includes an electrical insulation plate, and the second engagement part is formed in the electrical insulation plate.

6. The fuel cell stack according to claim 1, wherein each of the first end unit and the second end unit includes a terminal plate, and
each terminal plate has a through hole in which the communicating tube is fitted.
